(19) United States
(12) Patent Application Publication
(10) Pub. No.: US 2009/0052844 A1
(43) Pub. Date: Feb. 26, 2009

(54) Fiber optical connector

(76) Inventor: Hendrikus Petrus Gijsbertus Van Der Steen, Den Dungen Noord Brabant (NL)

Correspondence Address: HARRINGTON & SMITH, PC, 4 RESEARCH DRIVE, Suite 202, SHELTON, CT, 06484-6212, US

(21) Appl. No.: 11/665,082

(22) PCT Filed: Oct. 11, 2005
(86) PCT No.: PCT/EP05/10926

§ 371 Date: Oct. 30, 2008

(30) Foreign Application Priority Data
Oct. 11, 2004 (NL) 1027216

(51) Int. Cl. G02B 6/38

(52) U.S. Cl. 385/60

(57) ABSTRACT

The invention relates to a fiber optical connector including a housing with an axial passageway forming a longitudinal axis between a mating side and a rear side of said housing. A ferrule for fixating at least one optical fiber is disposed in said passageway, said ferrule having a front part, associated with said mating side of said housing, and a back part, associate with said rear side of said housing. The ferrule is arranged in said housing such that said back part of said ferrule is permitted to move transversely (D) to said longitudinal axis (L) to a larger extent than said front part. Accordingly, a fiber optical connector with a floating ferrule is obtained that has an improved installation performance, in particular with regard to decreasing the probability of damaging the ferrule.

The invention relates to a fiber optical connector comprising a housing with an axial passageway defining a longitudinal axis between a mating side and a rear side of said housing and a ferrule for fixating at least one optical fiber disposed in said passageway, said ferrule having a front part, associated with said mating side of said housing, and a back part, associated with said rear side of said housing.

Optical communications are conventionally implemented using multiple fiber optic cables in a series interconnected structure. Each fiber optic cable in the series is terminated with fiber optic connectors at separable interfaces between mating fiber optic cables. The purpose of the optical connectors is to securely and precisely align fiber cores of the mating fiber optic cables to permit light transmission from one fiber core to the next with minimum loss of optical energy.

One known fiber optic connector for high density applications uses a ferrule that houses a plurality of fibers. The ferrule has a plurality of fiber holes for receipt of respective fibers in a fiber optic cable. The mating ferrule has a respective plurality of fiber holes for receipt of respective fibers in the mating fiber optic cable. The holes in both ferrules are similarly positioned relative to each other so as to have a one to one correspondence and axial alignment between individual fibers when the ferrules are mated. In the conventional fiber array ferrule, fiber hole alignment is achieved using two precision guide pins and/or guide pin holes disposed on distal sides of a mating interface. The guide pin hole in a first ferrule receives the guide pin in the mating ferrule for precise alignment.

Conventionally, one ferrule may have one or two guide pins with the mating ferrule having one or no guide pins, respectively. It is the position of the guide pins and guide pin holes relative to the fiber holes and the precision of the fit between the guide pins and the guide pin holes that determine the alignment precision of the mated interconnection between fiber optic cables terminated with mating fiber array ferrules. Typically, there is a minimum amount of freedom of movement or float between the housing and the ferrule in order to assure adequate pre-mating alignment of the guide pin to guide pin hole. The close fit between the ferrule and housing together with annular lead-ins at the end of the guide pins to accommodate a certain degree of pre-mating misalignment and permit the guide pins and guide pins holes to perform the alignment function uninhibited.

A disadvantage in the close fit between the ferrule and the housing lies in the lack of isolation for the fiber array ferrule to external loads placed on the housing. US 2002/0186931 discloses an optical connector, wherein the position of the ferrule that is accommodated in the housing is uniquely determined in the housing before connection to a mating ferrule. After connection to the mating ferrule, the ferrule is put in a floating condition in the housing.

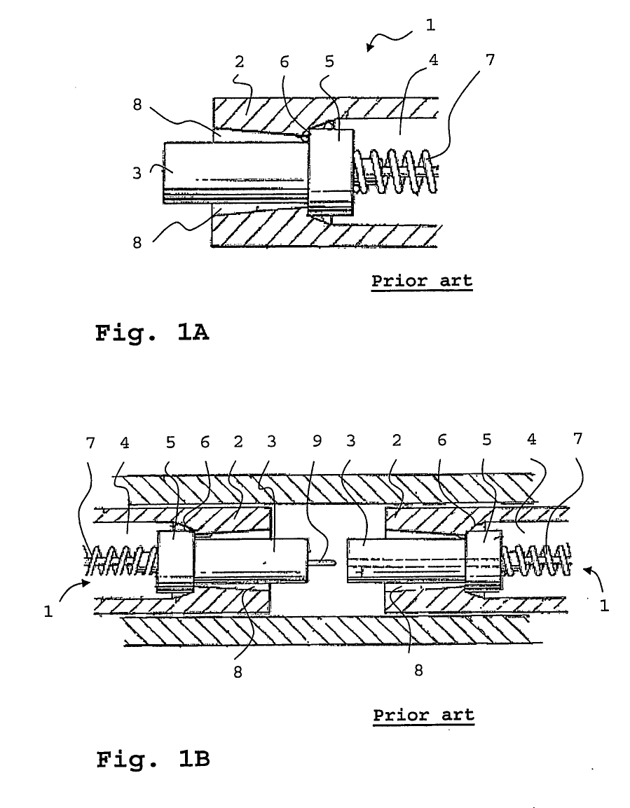

FIG. 1A shows this fiber optical connector 1 comprising a housing 2 having a ferrule 3 defined in a passageway 4 of the housing 2. The ferrule 3 comprises a collar 5 at the back side. The collar 5 interferes with a positioning face 6 in a tapered section of the passageway 4, when the ferrule 3 is not yet connected to a mating ferrule 3 (shown in FIG. 1B) but pressed against the positioning face 6 by the spring 7. On connection to the mating ferrule 3, the ferrule 3 moves backwardly and separates from the positioning face 6 and sufficient clearance is provided by the space 8 to allow movement of the ferrule 3. FIG. 1B shows a guiding pin 9.

As a floating ferrule is generally necessary to cope with external forces exerted on the connector, a floating ferrule provides problems for quick and non-destructive connection of a fiber optical connector. Typically ferrules are made of fragile or otherwise damage sensitive materials, that can easily get damaged by stubbing, i.e. the guiding pin is not correctly aligned with the guiding pin hole and contacts the ferrule incorrectly. The floating solution provided in US 2002/0186931 is not optimal as the space 8 still provides a possibility for the ferrule 3 to be misaligned in the housing before mating and further presupposes proper functioning of the spring 7. Also, high requirements should be met with regard to the planarity and the position of the collar 5 with respect to the positioning face 6.

It is an object of the invention to provide a fiber optical connector with a floating ferrule with improved installation performance, in particular decreasing the probability of damaging the ferrule.

This object is achieved by providing a fiber optical connector characterized in that said ferrule is arranged in said housing such that said back part of said ferrule is permitted to move transversely to said longitudinal axis to a larger extent than said front part. The front part of the ferrule is stabilized in terms of transverse displacement as compared to the back part of the ferrule, i.e. the clearance at the front side of the ferrule is less than at the backside. As the front part of the ferrule comprises the alignment elements, such as the guiding pins and/or guiding pin holes, the position of these alignment elements is sufficiently well defined by the limited freedom for transverse displacement of the front part of the ferrule and the alignment elements of a mating ferrule can safely cooperate with the alignment elements of the ferrule without damaging. Further, angular floating performance of the ferrule to absorb external loads when connected remains since the back part of the ferrule has sufficient room for transverse displacement.

In an embodiment of the invention, at least one of said ferrule and said housing is adapted to determine a pivot point for rotation of said ferrule in said passageway. Such a pivot point provides a truly stabilized front part of the ferrule as there is virtually no clearance at such a pivot point. Preferably, the pivot point is provided at or near said front part of said ferrule according to a preferred embodiment. In this preferred embodiment, the freedom of rotation for the back part of the ferrule is optimal, while the front part of the ferrule has no clearance and this is stable to ensure non-damaging insertion of a guiding pin.

In an embodiment of the invention, the passageway is adapted to provide a pivot point for rotation of said ferrule near a front side of the housing. Accordingly, standard ferrules can be applied. Preferably, this pivot point is provided by tapered faces of the housing at the mating side. Alternatively, the ferrule itself can limit play of the ferrule with respect to the front side of the housing.

In an embodiment of the invention, the ferrule is floatingly arranged in said passageway in a direction substantially parallel to said longitudinal axis. Accordingly, the fiber optical connector has a floating ferrule arrangement in all directions.

The invention will be further illustrated with reference to the attached drawings, which schematically show a preferred embodiment according to the invention. It will be understood that the invention is not in any way restricted to these specific and preferred embodiments.

In the drawings:

FIGS. 1A and 1B show a fiber optical connector of the prior art;

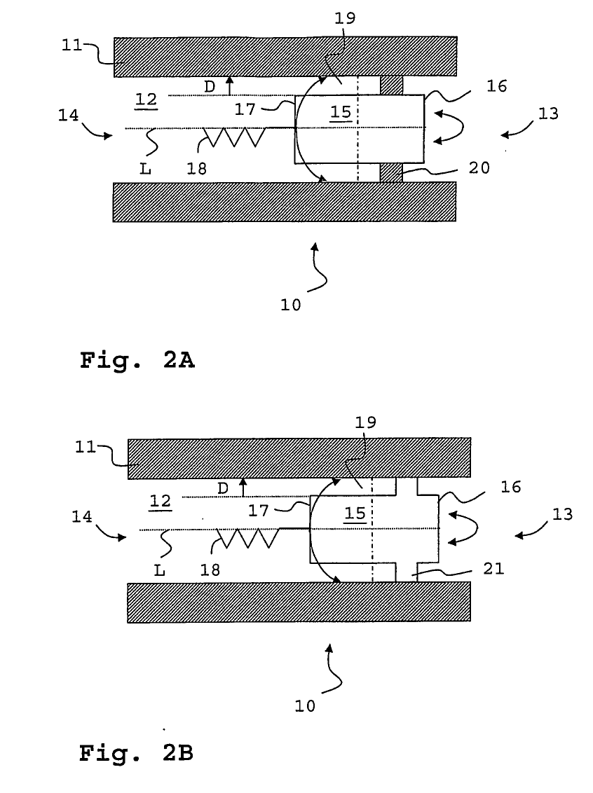

FIGS. 2A and 2B show schematic illustrations of a fiber optical connector according to an embodiment of the invention;

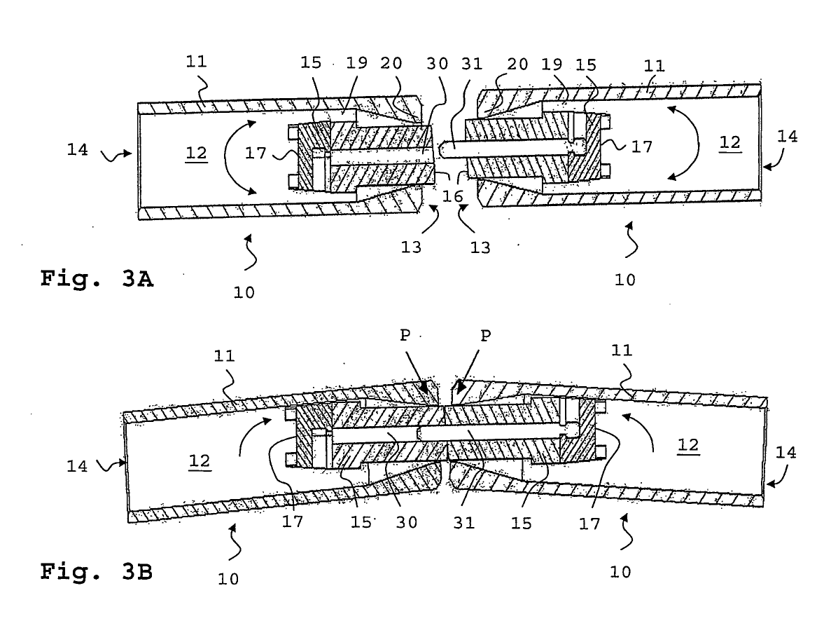

FIGS. 3A and 3B show cross-sections of a practical example of a fiber optical connector according to an embodiment of the invention before and after connection of the ferrules, and

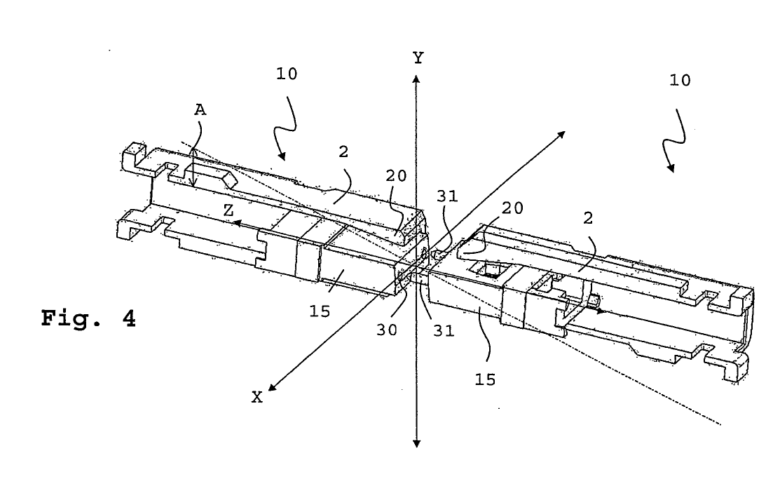

FIG. 4 shows a three-dimensional representation of fiber optical connector according to an embodiment of the invention.

FIGS. 2A and 2B show schematic illustrations of a fiber optical connector 10 comprising a housing 11 with an axial passageway 12 defining a longitudinal axis L between a mating side 13 and a rear side 14 of said housing 11. A ferrule 15 is disposed in the passageway 12 for fixating at least one optical fiber (not shown). The ferrule 15 has a front part 16, associated with the mating side 13 of the housing 11 and a back part 17, associated with the rear side 14 of the housing 11. The ferrule 15 is arranged in the housing 11 such that it can float in a direction parallel to the longitudinal axis L by means of a spring element 18.

The ferrule 15 is arranged in the housing 11 such that the back part 17 of the ferrule 15 is permitted to move transversely to the longitudinal axis L to a larger extent than the front part 16 of the ferrule 15. The effect is indicated by the curved arrows. The fiber optical connector 10 is constructed such that the back part 17 has the largest clearance to the wall of the housing 11. In particular, the back part 17 of the ferrule 15 can at least move over a transverse distance D, i.e. until the back part 17 meets the inner surface face of the passageway 12. The housing 11 is constructed to provide a space 19 allowing the displacement of the back part 17 of the ferrule 15.

If the fiber optical connector 10 is constructed such that a pivot point is determined for the ferrule 15, the transverse distance over which the back part 17 can move is longer than distance D. Such a pivot point can e.g. be determined by a structure 20 of the housing 12 (FIG. 2A) and/or a structure 21 of the ferrule 15 (FIG. 2B). In order to permit the ferrule 15 to have a transverse displacement D that is larger for the back part 17 than for the front part 16, the pivot point should be determined by arranging the structure 20, 21 not further than half of the longitudinal dimension of the ferrule 15, indicated by the dash-dotted line, calculated from the front part 16.

FIGS. 2A and 2B illustrate the principles of an embodiment according to the invention. FIGS. 3A, 3B and 4 depict a practical example of the embodiment of FIG. 2A (without the spring element 18). Identical reference numbers indicate identical or similar elements of the fiber optical connector 10. However, in this practical example, the front part 16 of the ferrule 15 may protrude from the mating side 13 of the fiber optical connector 10 to guarantee contact.

FIG. 3A shows two fiber optical connectors 10 according to the invention with alignment elements 30, 31, here a guiding pin 31 and corresponding guiding pin hole 30. The fiber optical connectors 10 are to be connected. In this phase, the ferrules 15 are positioned substantially parallel to the longitudinal axis L (see FIG. 2A) of the housing 11.

The guiding pin 31 and guiding hole 30 are misaligned in the X and Y direction (see FIG. 4). Consequently, for conventional fiber optical connectors 1, there would be a risk that the guiding pin 31 would damage the ferrule 15 by stubbing. However, according to the embodiment of the present invention, the guiding pins 31 enter the guiding pin holes 30 and the ferrule 15 rotates (angle float A) over the pivot point P (FIG. 3B) with respect to the longitudinal axis L defined by the housing 11 to correct for the angle misalignment and consequently, no stubbing by the guiding pins 31 to the ferrule 15 occurs. The pivot point P is determined by the tapered section 20 of the passageway 12 at the mating side 13 such that the ferrule 15 can rotate over a pivot point P near the front part 16 of the ferrule 15.

FIG. 4 displays a three dimensional representation of the situation of FIG. 3A.

The invention can be particularly relevant for connectors in so-called feed-through backplane adapters.

1. A fiber optical connector comprising a housing with an axial passageway defining a longitudinal axis (L) between a mating side and a rear side of said housing and a ferrule for fixating at least one optical fiber disposed in said passageway, said ferrule having a front part, associated with said mating side of said housing, and a back part, associated with said rear side of said housing characterized in that said ferrule is arranged in said housing such that said back part of said ferrule is permitted to move transversely (D) to said longitudinal axis (L) to a larger extent than said front part.

2. The fiber optical connector according to claim 1, wherein at least one of said ferrule and said housing is adapted to determine a pivot point (P) for rotation of said ferrule in said passageway.

3. The fiber optical connector according to claim 2, wherein at least one of said ferrule and said housing is adapted to determine said pivot point (P) at or near said front part of said ferrule.

4. The fiber optical connector according to claim 1, wherein said passageway comprises a structure adapted to provide a pivot point (P) for rotation of for said ferrule.

5. The fiber optical connector according to claim 4, wherein said passageway has tapered faces at said mating side to provide said pivot point.

6. The fiber optical connector according to claim 1, wherein said ferrule is floatingly arranged in said passageway in a direction (Z) substantially parallel to said longitudinal axis (L).
